(19) United States
(12) Patent Application Publication
(10) Pub. No.: US 2026/0288067 A1
(43) Pub. Date: Sep. 24, 2026

(54) TIMEPIECE DIAL DEVICE

(71) Applicant: ROLEX SA, Geneva (CH)

(72) Inventors: Christophe Linstrument, Bonneville (FR); Nicolas Moretti, Chilly (FR); Christophe Paillot, Sciez (FR); Aurélien Thabuis, La Roche-sur-Foron (FR)

(73) Assignee: ROLEX SA, Geneva (CH)

(21) Appl. No.: 19/575,050

(22) Filed: Mar. 23, 2026

(30) Foreign Application Priority Data
Mar. 24, 2025 (EP) 25165523.9

(51) Int. Cl. G04B 19/10

(52) U.S. Cl. CPC G04B 19/10

(57) ABSTRACT

The timepiece dial includes a dial plate (1), an applique (2), and a pressing element (3), the applique (2) being retained between the dial plate (1) and the pressing element (3).

### CROSS-REFERENCE TO RELATED APPLICATION

This application claims priority of European patent application No. EP25165523.9 filed Mar. 24, 2025, the content of which is hereby incorporated by reference herein in its entirety.

### FIELD OF THE INVENTION

The invention relates to a timepiece dial. The invention also relates to a timepiece comprising such a dial.

### BACKGROUND ART

Complication watches generally comprise on their dials dedicated zones for displaying said complications, such as counters. These counters can take the form of one or more appliques attached to the dial plate.

Several techniques are used to assemble these appliques on the dial plate, such as gluing. The advantage of this technique is that the appliques can be decorated separately from the dial plate, for example with new decorations, new materials, and new finishes, while positioning them flush with the dial plate. However, this solution is complex as it requires precise metering of the glue and control of parameters that are subject to change over time. Current techniques often result in a very thick assembly, with the thickness of the appliques added to the thickness of the dial plate and the fastening devices.

In addition, these techniques are often complicated, and imply various problems such as misalignment of the appliques, or complex fastenings that can damage the dial plate.

Application EP3712713 describes an assembly with rivets machined on a dial plate that cooperate with holes made in an applique, and an assembly with rivets present on the applique that cooperate with holes made in the dial plate.

Patent applications have been filed for other devices for mechanically assembling counters on a dial plate. For example, patent application CH712002 proposes a removable, interchangeable assembly of counter appliques on a dial plate. Each counter applique comprises a ring that is inserted into an opening in the dial plate. Each dial plate opening comprises an elastic element adapted to the geometry of the ring that makes it possible to hold the ring in position. This elastic element can be manipulated in order to remove the applique. This design has several drawbacks: it is very complex and takes up a lot of space above and below the dial plate, that is, it is bulky in the direction of the thickness of the dial. EP3185086 proposes a watch dial applique comprising riveting feet, each one being provided with a plastically deformable free end. The plastically deformable zone comprises a hollow or a crack initiation.

### SUMMARY OF THE INVENTION

The aim of the invention is to provide a dial that improves the devices known in the prior art. The invention particularly proposes a dial comprising appliques, in particular counter appliques, having various materials and decorations on the dial. The invention also makes it possible to produce flush assemblies.

A dial according to the invention is defined in point 1 below.
1. A timepiece dial comprising:
   a dial plate,
   an applique, and
   a pressing element, the applique being retained between the dial plate and the pressing element.

Different embodiments of the dial device are defined in points 2 to 14 below.
2. The dial as defined in point 1, wherein the dial plate comprises at least one first positioning and/or fastening element and wherein the pressing element comprises at least one second positioning and/or fastening element cooperating with the at least one first element.
3. The dial as defined in one of the preceding points, wherein the dial comprises interface surfaces between the dial plate and the pressing element arranged in the thickness of the dial plate and/or arranged in the thickness of the applique and/or arranged in the thickness of the pressing element.
4. The dial as defined in point 2 or 3, wherein the at least one first positioning and/or fastening element comprises a foot or a hole and/or wherein the at least one second positioning and/or fastening element comprises a hole or a foot.
5. The dial as defined in the preceding point, wherein the foot comprises a deformable end, in particular a rivet end.
6. The dial as defined in one of the preceding points, wherein the dial plate and/or the pressing element is provided with an opening for receiving the applique, the dial plate and/or the pressing element comprising at least one third positioning element, the applique comprising at least one fourth positioning element cooperating with the at least one third element.
7. The dial as defined in one of the preceding points, wherein the dial comprises interface surfaces between the dial plate and the applique arranged in the thickness of the dial plate and/or arranged in the thickness of the applique and/or arranged in the thickness of the pressing element and/or wherein the dial comprises interface surfaces between the pressing element and the applique arranged in the thickness of the dial plate and/or arranged in the thickness of the applique and/or arranged in the thickness of the pressing element.
8. The dial as defined in one of the preceding points, wherein the applique comprises at least one first projection outside a first visible zone of the applique.
9. The dial as defined in point 8 and as defined in point 6, wherein the at least one fourth positioning and/or fastening element is formed by the at least one first projection.
10. The dial as defined in point 9, wherein the at least one third positioning element comprises at least one first recess for receiving the at least one fourth positioning element.
11. The dial as defined in one of the preceding points and as defined in point 2, wherein the at least one first positioning and/or fastening element comprises feet provided on an inner face of the dial plate, in particular on an interface surface between the dial plate and the pressing element.
12. The dial as defined in one of points 1 to 10 and as defined in point 2, wherein the at least one second positioning and/or fastening element comprises feet provided on an inner face of the pressing element, in particular on the interface surface between the dial plate and the pressing element.
13. The dial as defined in one of the preceding points, wherein the visible surfaces of at least two of the three members below:
   the dial plate,
   the applique,
   the pressing element, are flush.
14. The dial as defined in one of the preceding points, wherein:
   the applique is disk-shaped and the pressing element is annular, or
   the applique is annular and the pressing element is disk-shaped.

A timepiece according to the invention is defined in point 15 below.
15. A timepiece, in particular a wristwatch, comprising a dial as defined in one of points 1 to 14.

### BRIEF DESCRIPTION OF THE DRAWINGS

The appended figures show, by way of example, two embodiments of a timepiece according to the invention.

FIG. 1 is a perspective view of a first embodiment of a timepiece according to the invention, comprising a first embodiment of a dial according to the invention.

FIG. 2 is an exploded perspective top view of the first embodiment of the dial.

FIG. 3 is an exploded perspective bottom view of the first embodiment of the dial.

FIG. 4 is a perspective view of a pressing element of the first embodiment of the dial.

FIG. 5 is a perspective view of a dial plate of the first embodiment of the dial.

FIG. 6 is a perspective view of an applique of the first embodiment of the dial.

FIG. 7 is a top view of the dial of one embodiment of the dial.

FIG. 8 is a partial longitudinal cross-sectional view of a dial according to the first embodiment of the dial.

FIG. 9 shows two partial longitudinal cross-sectional views of a dial according to the first embodiment of the dial in line with fastening elements, one view before fastening and one view after fastening.

FIG. 10 is an exploded perspective bottom view of a second embodiment of a timepiece according to the invention, comprising a second embodiment of a dial according to the invention.

FIG. 11 is a partial exploded perspective view of the second embodiment of the dial according to the invention.

FIG. 12 is a partial perspective view of the second embodiment of the dial according to the invention.

FIG. 13 is another partial perspective view of the second embodiment of the dial according to the invention.

FIG. 14 is a partial exploded perspective view of a variant of the second embodiment of the dial according to the invention.

### DETAILED DESCRIPTION OF PARTICULAR EMBODIMENTS

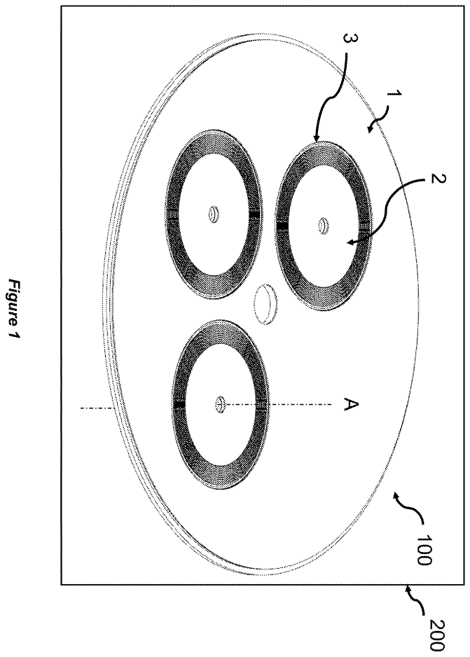

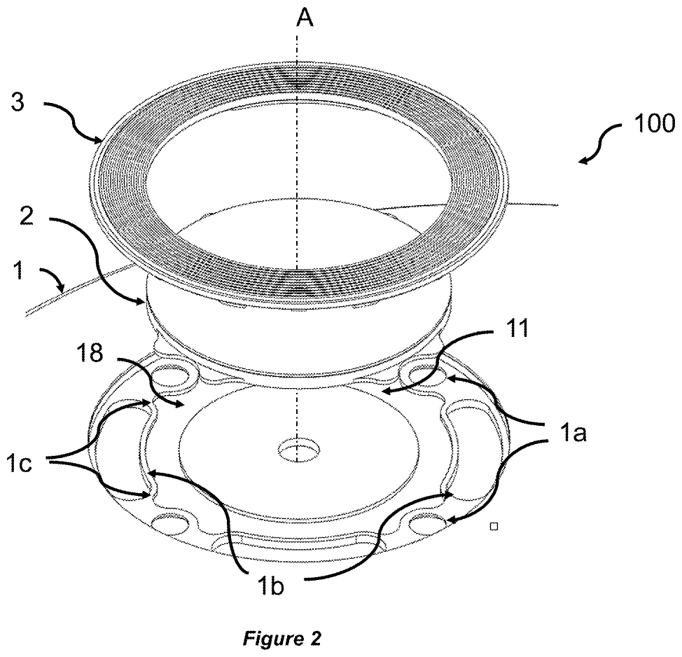

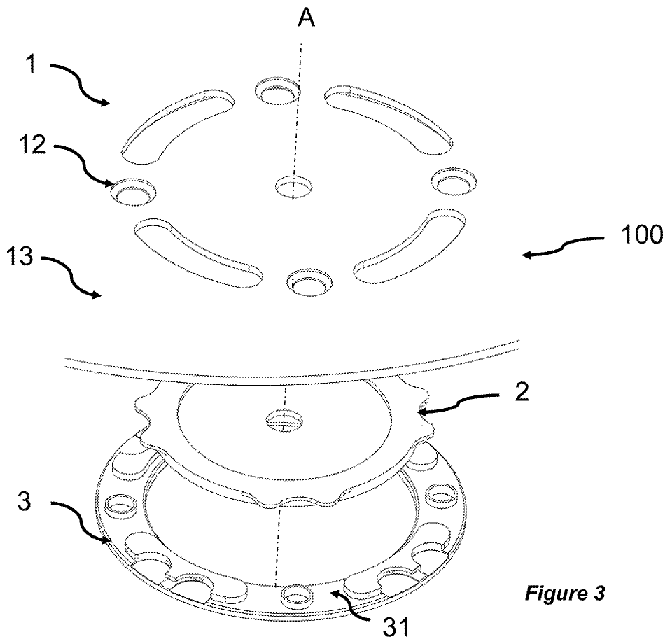

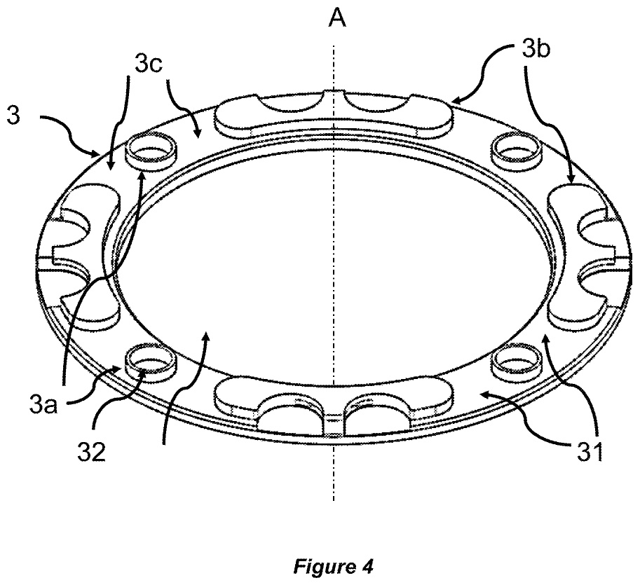

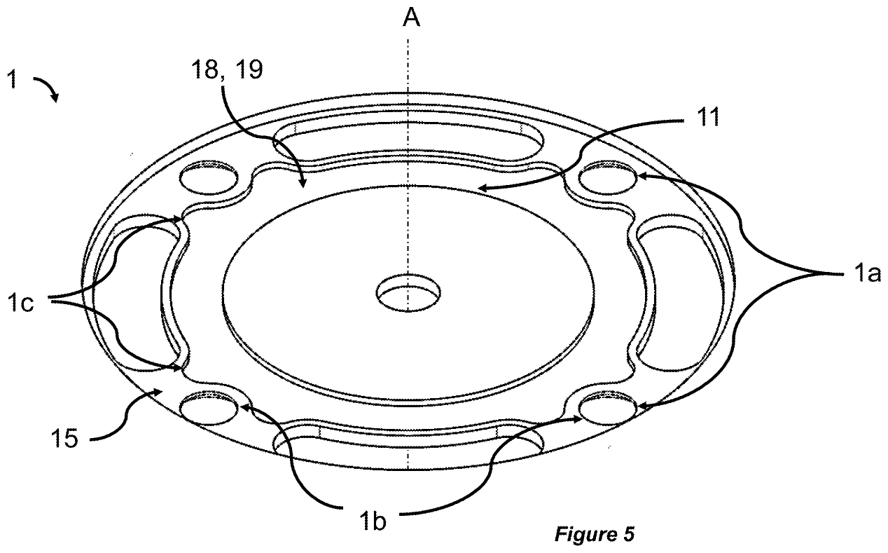

A first embodiment of a timepiece 200 according to the invention is described below with reference to FIGS. 1 to 9.

The timepiece 200 is for example a wristwatch. The timepiece preferably comprises a watch case, a timepiece movement, and a first embodiment of a timepiece dial 100. The dial 100 is fastened to the movement, in particular to a frame of the timepiece movement.

For example, the dial 100 can comprise fastening feet, in particular fastening feet provided on the dial plate, cooperating with fastening holes in the timepiece movement.

The dial-timepiece movement assembly is fixedly mounted in the watch case.

The timepiece movement can be an electronic movement, a hybrid movement, or a mechanical movement, in particular an automatic movement.

Throughout this document, “inner surface” is given to mean a surface of a component facing toward the timepiece movement. “Outer surface” is given to mean a surface of the component on the opposite side from an inner surface of such a component. Thus:
at least the majority of the outer surfaces of the components of the dials according to the invention are visible to the user of the timepiece through a glass of the timepiece, and
unless transparent materials are used, none of the inner surfaces of the components of the dials according to the invention is visible to the user of the timepiece.

The Dial 100 comprises:
a dial plate 1,
at least one applique 2, and
at least one pressing element 3.

In the first embodiment, the dial 100 can comprise:
three appliques, and
three pressing elements.

The dial can comprise any other number of appliques, in particular two, four, or five appliques.

One, several or all of the appliques can be assembled according to the invention.

Preferably, the dial plate 1, the appliques 2, and the pressing elements 3 are separate or independent components. Preferably, they do not form part of each other.

Hereinafter, for simplicity, the structure and fastening of a single applique are described.

The applique 2 is retained between the dial plate 1 and the pressing element 3. In other words, in a direction or along an axis A perpendicular to the dial and preferably centered on each applique 2, the applique 2 is at least partially sandwiched or positioned between:
the dial plate 1, and
the pressing element 3.

In other words, the applique 2 is limited along the axis A by:
the dial plate 1 on one side, and
the pressing element 3 on the other side.

The pressing force or the pressing action is exerted along the axis A.

The applique 2 is thus attached, fastened by pressing between the pressing element 3 and a dial plate 1. The pressing element 3 and the dial plate 1 are advantageously assembled by riveting. This assembly advantageously forms a counter, particularly a dial counter for a chronograph watch.

The dial plate 1 has a thickness e1 measured along the axis A.

The applique 2 has a thickness e2 measured along the axis A.

The pressing element 3 has a thickness e3 measured along the axis A.

According to a preferred first embodiment, the pressing element 3 is fastened above the dial plate 1. The dial plate 1 comprises a cut-out 11 (blind or through or a combination) for receiving the pressing element 3 and the applique 2. The pressing element 3 comprises a plurality of feet 3a intended to be inserted and riveted into guide and/or mechanical fastening means 1a, which take the form of through-openings 1a, present in the cut-out 11 of the dial plate 1. The cooperation between the guide and/or mechanical fastening means 1a and the riveting feet 3a makes it possible to assemble the pressing element 3 on the dial plate 1.

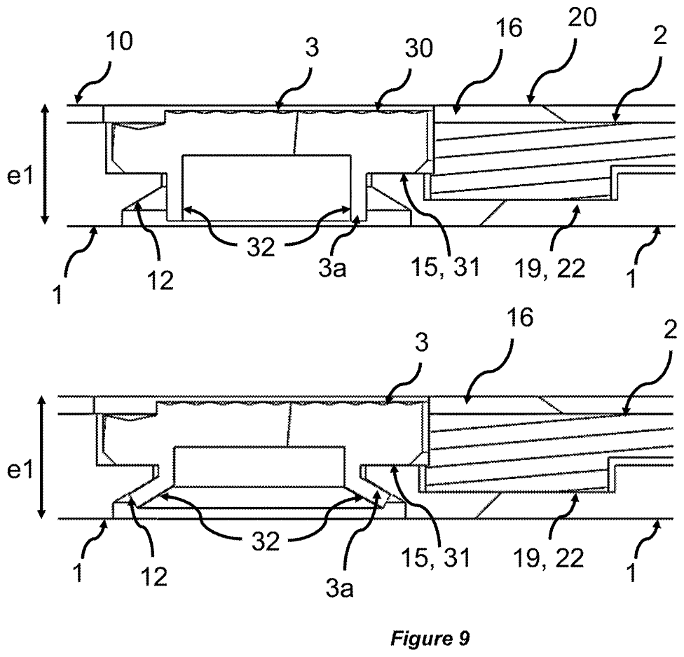

These riveting feet 3a extend perpendicularly or substantially perpendicularly to the inner surface 31 of the pressing element 3 and preferably comprise a plastically deformable end 32 to facilitate riveting, for example through the formation of a hollow or a zone of reduced mechanical strength at the end 32 of the feet 3a (making it possible to facilitate and ensure the location of the plastic deformation). The dial is shown with the feet 3a undeformed in the left-hand view in FIG. 9 and is shown with the feet 3a deformed in the right-hand view in FIG. 9.

These feet can be integrally formed with the pressing element from the inner surface 31. Alternatively, they can be attached to the part by methods such as driving, brazing, or soldering. To this end, holes for receiving the feet can be made in the pressing element.

Advantageously, each opening 1a is provided with a bevel 12 on the inner surface 13 of the dial plate 1 in order to reduce the stress exerted during riveting on the plastically deformable part of the foot. The aim of this is also to prevent material becoming detached and minimize the risk of damage to the pressing element or the dial plate. A further aim of this is to contain the fastening means in the thickness of the dial, without them extending beyond this thickness.

Positioning and/or reinforcing elements 3b, protruding from the inner surface 31, can also be provided on the pressing element 3. These positioning elements 3b are incorporated so that they cooperate with corresponding guide means 1b, facilitating installation by the watchmaker or operator and reinforcing the pressing element 3. These guide means 1b take the form of openings 1b for example, which can be through-openings or blind openings.

There are preferably three or more riveting feet 3a. In addition, the riveting feet 3a are preferably evenly distributed about the axis A. The guide and/or mechanical fastening means 1a and the guide means 1b respectively have geometries that complement those of the riveting feet 3a and the positioning and/or reinforcing elements 3b.

The positioning and/or reinforcing elements 3b can be combined with the riveting feet 3a so as to optimize the area available on each of the parts. By way of non-limiting example, a through-opening 1a in the dial plate 1, designed to complement a riveting foot 3a of the pressing element 3, can be positioned adjoining a blind guide opening 1b of the dial plate 1, designed to complement a positioning element 3b of the pressing element 3.

Preferably, the thickness of the dial plate 1 is reduced at its contact interface with the pressing element 3, so as to reduce the overall thickness of the assembly once the two components have been assembled. The extent to which the parts are flush can thus be carefully selected.

The fastening is preferably invisible, which means that riveting performed on the inner surface 13 of the dial plate 1 is advantageous.

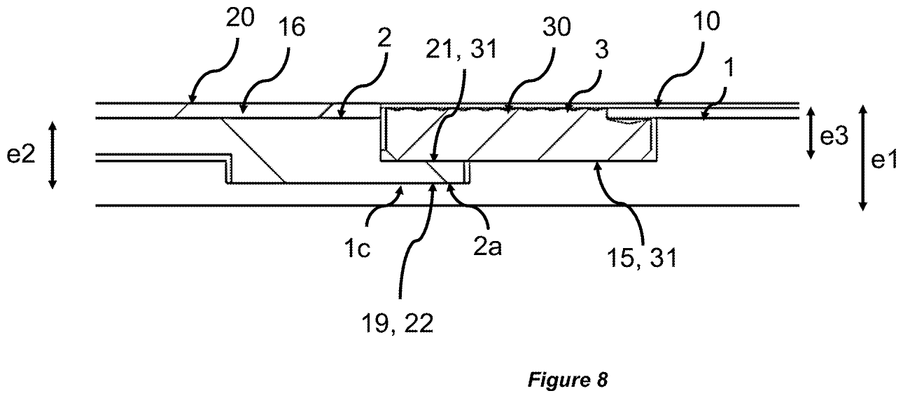

As shown in FIG. 8:
the applique 2 has a first surface 21 bearing against the inner surface 31 of the pressing element 3, and
the applique 2 has a second surface 22 bearing against a surface 19 of the dial plate 1, and
the pressing element 3 has a surface 31 bearing against a surface 15 of the dial plate 1.

Preferably, the chain of dimensions of the components of the dial causes the applique to be clamped between the dial plate and the pressing element, when the pressing element is fastened to the dial plate. The clamping or tightening can be less than 9 μm, or less than 6 μm, or less than 3 μm. As an alternative, chain of dimensions of the components of the dial can be envisaged with slight play, in particular less than 9 μm, or less than 6 μm, or less than 3 μm, of the applique between the dial plate and the pressing element, when the pressing element is fastened to the dial plate.

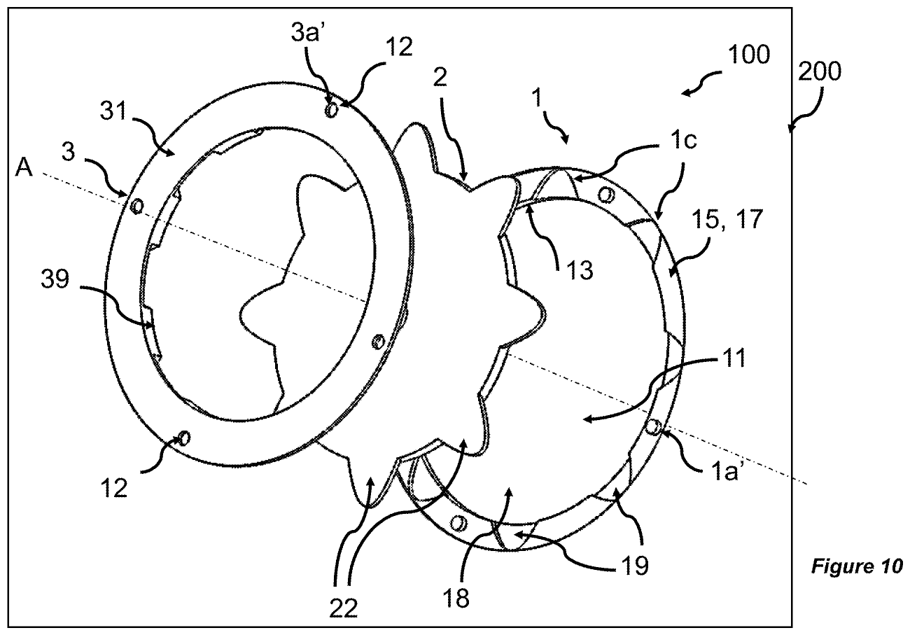

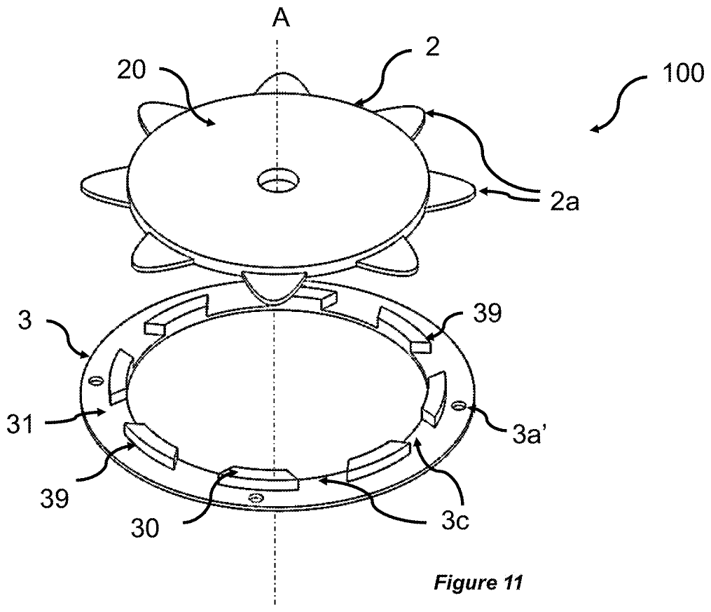

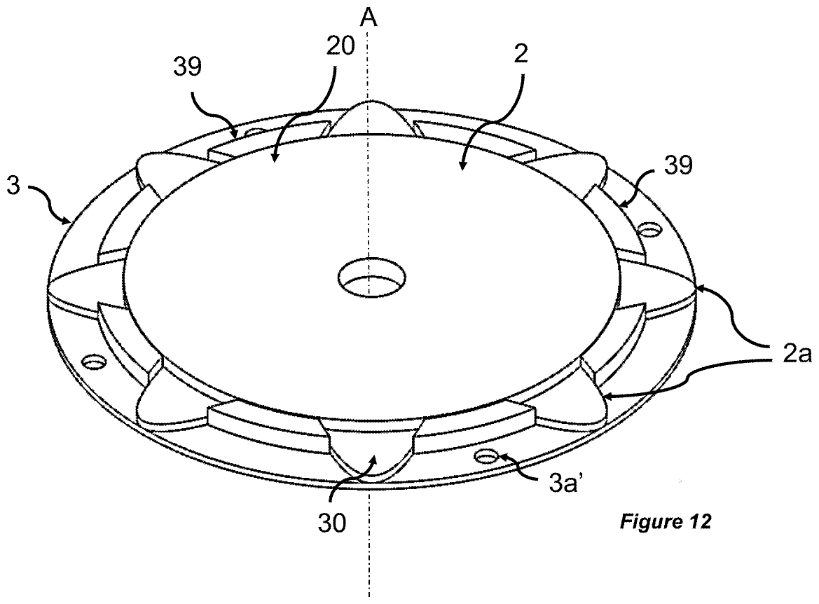

A second embodiment of a timepiece 200 according to the invention is described below with reference to FIGS. 10 to 14.

The timepiece 200 is for example a wristwatch. The timepiece preferably comprises a watch case, a timepiece movement, and a second embodiment of a timepiece dial 100. The dial 100 is fastened to the movement, in particular to a frame of the timepiece movement.

For example, the dial 100 can comprise fastening feet cooperating with fastening holes in the timepiece movement.

The dial-timepiece movement assembly is fixedly mounted in the watch case.

The timepiece movement can be an electronic movement, or a hybrid movement, or a mechanical movement, in particular an automatic movement.

Preferably, the second embodiment differs from the first embodiment preferably solely in that the pressing element is fastened below the dial plate 1. The dial plate 1 has a through cut-out 18 so that the applique 2, and possibly the pressing element 3, is/are visible from the outside of the timepiece, through the glass. The through cut-out can form an opening for receiving the applique.

Advantageously, the pressing element 3 comprises a plurality of guide and/or mechanical fastening means 3a′, which take the form of openings, allowing the insertion and riveting of feet 1a′ present on the edge 17 of the cut-out 18 in the dial plate 1. The cooperation between the guide and/or mechanical fastening means 3a′ and the riveting feet 1a′ makes it possible to assemble the pressing element 3 on the dial plate 1.

It will be noted that in this embodiment, there is a chance that the pressing element 3 will be less visible, or even invisible, once the applique has been added, unless specifically designed otherwise.

The riveting feet 1a′ extend perpendicularly or substantially perpendicularly to the inner surface 13 of the dial plate 1 and preferably comprise a plastically deformable end to facilitate riveting, for example through the formation of a hollow or an area of reduced mechanical strength at the end of the riveting foot (making it possible to facilitate and ensure the location of the plastic deformation).

The feet 1a′ are integrally formed with the dial plate from an inner surface 17. Alternatively, the feet can be attached to the dial plate by methods such as driving, brazing, or soldering. To this end, the feet can be received in holes.

Each opening 3a′ is preferably provided with a bevel 12 on the inner surface 31 in order to reduce the stress exerted during riveting on the plastically deformable part of the foot 1a′. The aim of this is also to prevent material becoming detached and minimize the risk of damage to the pressing element or the dial plate.

Positioning and/or reinforcing elements 1b′, protruding from the inner surface of the dial plate 1, can also be formed. These positioning and/or reinforcing elements 1b′ can be incorporated so that they cooperate with guide means 3b′ of the pressing element 3. The cooperation between these elements and means facilitates and increases the reliability of the installation of the pressing element on the dial plate by the watchmaker. These guide means can take the form of blind openings.

There are preferably three or more riveting feet 1a′. The riveting feet 1a′ are preferably evenly distributed about the axis A. The guide and/or mechanical fastening means and the guide means provided on the pressing element respectively have geometries that complement those of the riveting feet 1a′ and the positioning and/or reinforcing elements of the dial plate 1.

The positioning and/or reinforcing elements can be combined with the riveting feet so as to optimize the space on the dial elements. By way of non-limiting example, a through-opening, designed to cooperate with a riveting foot, can be positioned adjoining a guide opening, designed to cooperate with a positioning and/or reinforcing element.

Preferably, the thickness of the dial plate is reduced at its contact interface with the pressing element, so as to reduce the overall thickness once the two components have been assembled. The extent to which the parts are flush can thus be carefully selected.

Preferably, the fastening should be invisible. The riveting is thus advantageously performed on the inner surface of the pressing element.

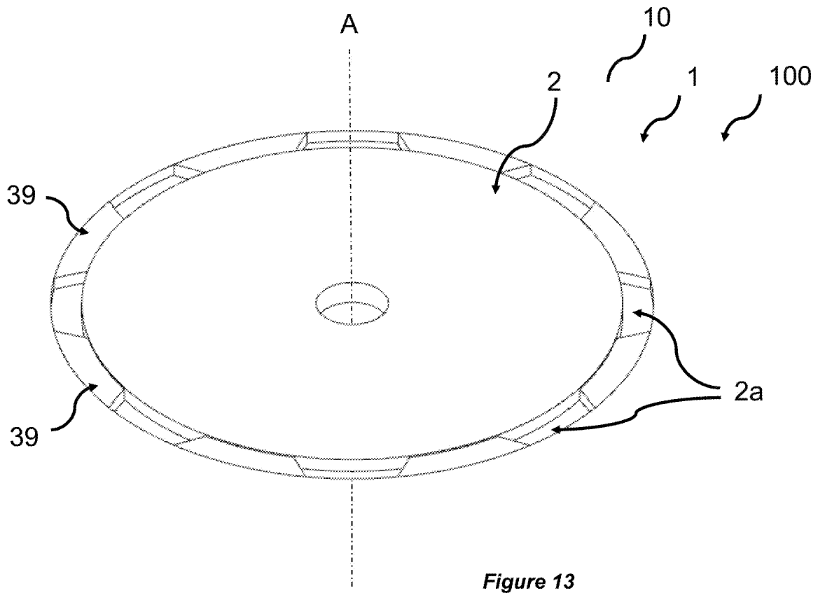

In this second embodiment, the pressing element 3 can have protrusions 39 extending in the direction of the axis A. These protrusions have cross-sections transverse to the axis A (perpendicular to the axis A) in the shape of ring segments extending tangentially and parallel to the axis A. The ends of the protrusions 39 form the outer surface 30 of the pressing element. The transverse cross-sections of the protrusions 39 complement the geometries of the applique 2 and the dial plate 1. The pressing element 3 can thus be fully positioned, in particular positioned with minimum play, relative to the applique and relative to the dial plate, in a plane perpendicular to the axis A. The protrusions 39 can also increase the stiffness or mechanical strength of the pressing element 3. The ends of the protrusions 39 can be visible between the outer surfaces of the applique and the dial plate as illustrated in FIG. 13.

As an alternative, the pressing element can be without protrusions 39 or have protrusions that are not visible once the dial has been assembled.

The protrusions 39 can have a height (measured along the axis A) the value of which is:
equal to or of the order of the thickness e1 of the dial plate 1, or
equal to or of the order of the thickness e2 of the applique 2.

Alternatively, the protrusions 39 can have a height less than the thickness e1 or the thickness e2. Such a limited height can allow the protrusions to be hidden by the dial plate or the applique 2 once the dial has been assembled.

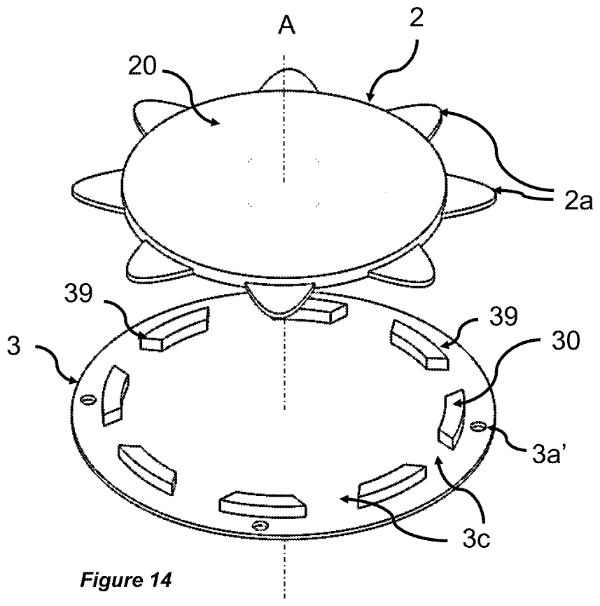

In a second variant of the second embodiment (shown in FIG. 14), the pressing element 3 does not have a central opening, unlike in the first variant described with reference to FIGS. 10 to 13. Likewise, the applique can:
be without an opening, or
have one or more openings that do not have a functional role, but a decorative role.

Preferably, this second variant differs from the first variant solely with respect to these features.

Whatever the embodiment and variant, before the dial plate 1 and the pressing element 3 are assembled, the applique 2 is first positioned on the dial plate 1 (or on the pressing element). To this end, the applique 2 advantageously comprises projections 2a that extend on the periphery of the applique, radially relative to the axis A, and outward. These projections 2a are intended to be in contact with the dial plate 1 and with the pressing element 3 in order to retain the applique 2 by pressing. Recesses 3c, 1c can be provided on the pressing element and/or on the dial plate for receiving the projections 2a.

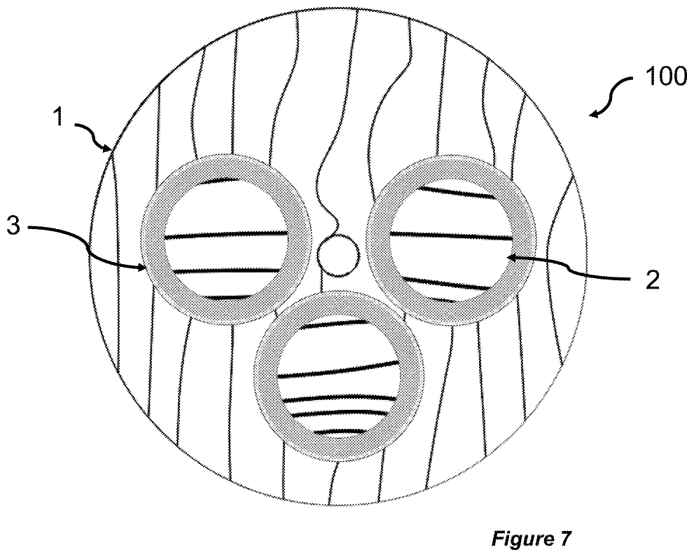

These projections 2a perform several functions:
The projections 2a ensure pre-positioning and angular locating. They ensure the correct orientation of the applique relative to the dial plate and/or the pressing element before fastening by pressing, by cooperating with the respective recesses 3c, 1c present on the pressing element and/or the dial plate. The projections also make it possible to index the counter appliques relative to each other. This function is particularly beneficial for obtaining an esthetic effect: counter appliques made from a material with a marked structure and streaking, such as mother of pearl, can thus be aligned elegantly, as illustrated in FIG. 7.

The projections 2a retain the applique by pressing. The projections provide a contact surface with the pressing element and the dial plate, thus allowing retention by pressing in a direction parallel to the axis A.

The projections 2a ensure lateral stability. They prevent the movement of the applique in a plane perpendicular to the axis A, by cooperating with the respective recesses 3c, 1c present on the pressing element and/or the dial plate.

These projections 2a preferably take the form of lobes projecting toward the outside of the applique. The recesses 3c, 1c present on the pressing element and/or the dial plate preferably have geometries that complement those of the projections 2a, ensuring a precise fit.

Whatever the embodiment and variant, the dial advantageously comprises:
interface surfaces 15, 31 between the dial plate and the pressing element arranged in the thickness e1 of the dial plate 1 and/or arranged in the thickness e2 of the applique 2 and/or arranged in the thickness e3 of the pressing element 3, and/or
interface surfaces 19, 22 between the dial plate and the applique arranged in the thickness e1 of the dial plate and/or arranged in the thickness e2 of the applique 2 and/or arranged in the thickness e3 of the pressing element 3, and/or
interface surfaces 31, 21 between the pressing element and the applique arranged in the thickness e1 of the dial plate and/or arranged in the thickness e2 of the applique 2 and/or arranged in the thickness e3 of the pressing element 3.

“Surface arranged in the thickness of an element” is given to mean that the surface is arranged between two planes perpendicular to the axis A, each plane being tangent to the element.

In other words, the interfaces between elements 1, 2, and 3 can be arranged at different levels defined by specific geometries of the elements 1, 2, and 3.

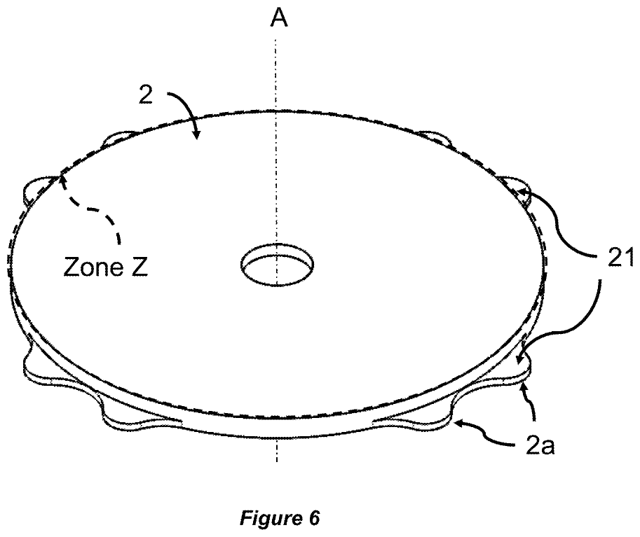

Whatever the embodiment and variant, the projections 2a are preferably outside a first visible zone Z of the applique, so that the projections are not visible to the user of the timepiece. Such a zone Z is for example shown in dashed lines in FIG. 6.

Alternatively, the projections 2a can be partially visible in some variants or embodiments.

Whatever the embodiment and variant, preferably, at least one pair of surfaces (10, 20), (10, 30), (20, 30) among the visible surfaces 10, 20, 30 of the three members below:
the dial plate 1,
the applique 2,
the pressing element 3, has flush surfaces.

“Flush”, is given to mean that the difference in level between the two surfaces, measured parallel to the axis A, is less than 60 μm.

In the embodiments described, the applique 2 is generally disk-shaped, possibly with a hole at its center, for example provided for a staff or a pipe of a hand to pass through. However, whatever the embodiment or variant, the applique can be any shape. In particular, the applique can be a plate with any outline. For example, the applique can have any geometric outline, in particular any substantially polygonal outline.

In the embodiments described, the pressing element 3 is:
mainly annular in the first embodiment and in the first variant of the second embodiment, and
mainly in the form of a plate, in particular a disk, in the second variant of the second embodiment.

Whatever the embodiment and variant, the pressing element 3 can be annular, in particular circular annular. The pressing element 3 can thus be a ring. The circular shape can be full or closed. Alternatively, the circular shape can be open or interrupted, that is, the circular shape can comprise a cut or an opening on its perimeter.

However, whatever the embodiment or variant, the pressing element 3 can be any shape. In particular, the pressing element can be a ring of any shape, that is, not necessarily circular. For example, the pressing element can have any geometric outline, in particular any substantially polygonal outline.

In one embodiment (not shown), the applique can be annular and the pressing element can be in the form of a plate, the applique being retained by being positioned between the dial plate and the pressing element.

Preferably, in the different embodiments and variants, on the visible surface of the dial, one or more visible surfaces 30 of the pressing element 3 surround(s) a visible surface 20 of the applique 2 in an opening or a plurality of openings made on a visible surface 10 of the dial plate 1.

In other words, the solutions according to the invention consist of an assembly of an applique fastened by pressing between a pressing element, such as a ring, and a dial plate, the ring and the dial plate being assembled for example by riveting and/or driving and/or gluing and/or brazing and/or soldering.

The solutions described above make it possible to obtain dials with enhanced decorations. The solutions makes it possible to mount appliques on a dial plate with minimal mechanical stress, thus facilitating the incorporation of fragile or breakable materials in a reliable, repeatable, and durable manner, without using glue.

Whatever the embodiment and variant, the appliques can comprise a material selected from a stone, a fine stone, a semiprecious or ornamental stone, a precious substance of organic origin, a mineral, an substance of organo-mineral origin, a gem, a rock, a fossil material, such as for example a mother of pearl, a shell, a manganocalcite, a lepidolite, a silicified wood, a coral, amber, a pearl, a sphalerite, a fluorite, an agate, an alexandrite, an amethyst, an anatase, an aventurine, a chalcedony, a chrysoberyl, a topaz, a citrine, a jasper, a tiger's eye, an opal, a quartz, a spinel, an aragonite, an azurite, a malachite, a crocoite, an apatite, a lazulite, a turquoise, an aquamarine, a beryl, a tourmaline, a cornelian, an obsidian, or a snowflake obsidian; a metal, such as gold, or platinum, or a metal alloy, such as ferrite, a gold alloy, a titanium alloy, a damascus steel, brass, or meteorite, or a metal composite, such as a multilayer alloy, a metal-ceramic composite, such as a cermet or a multilayer composite, or a composite comprising at least two of the constituents selected from glass, ceramic, metal alloys, polymers, and organic natural materials such as wood; and an engineering ceramic based on pigmented or unpigmented zirconia and/or alumina.

Whatever the embodiment and variant, the appliques can either be integrally formed, or provided with a leaf made from one of the aforementioned materials that is added to a base or substrate, in particular made from metal.

Whatever the embodiment and variant, the pressing element can preferably be made from metal or a metal alloy, for example from brass, gold, platinum, a gold alloy, or a titanium alloy. The pressing element can also be made from an at least partially amorphous metal alloy, a shape memory metal alloy, a metal composite, or a polymer, such as a thermoplastic.

Whatever the embodiment and variant, the dial plate is preferably made from metal, for example from brass, gold, platinum, a gold alloy, or a titanium alloy. The dial plate can also be made from a ceramic, in particular zirconia. Its upper surface can also be decorated with one or more attached elements made from a material forming the appliques. Alternatively, the dial plate can be integrally formed and manufactured from a material forming the appliques.

Whatever the embodiment and variant, the riveting feet must be made from a plastically deformable material, whether they are on the dial plate or the pressing element. The riveting feet can in particular be attached to the component in question using a material specifically suitable for riveting.

Whatever the embodiment and variant, the outer surfaces of the different components are preferably different. The decorations can comprise the fine structuring of a given surface having surface reliefs, engine turning, sunray finishing, chiseling, engraving, circular graining, snailing, circling, chamfering, satin finishing, drawing, sinking, Geneva stripes, or clous de Paris embossing. Whatever the embodiment and variant, materials such as mother of pearl, stone, or wood, can be used to form natural surface decorations, such as streaking, cloud effects, or Widmanstätten patterns, which it is advantageous to highlight. For example, as illustrated in FIG. 7, it can be appropriate to align the streaking of the decorations, in particular mother of pearl, of different appliques in order to obtain a harmonious esthetic effect.

Whatever the embodiment and variant, the pressing element and the applique can be arranged in the thickness e1 of the dial plate, in particular the applique and all the elements used to secure the applique to the dial plate can be arranged in the thickness e1 of the dial plate.

Finally, whatever the embodiment and variant, the surfaces of the components can undergo one or more steps of partial or full coating 16 by depositing a transparent or semi-transparent material using a dry method or using a PVD, CVD, ALD, lacquering, or zaponing method. Such coating of the outer face of the dial plate is illustrated in FIGS. 8 and 9 and denoted by reference sign 16.

Throughout this document, the notion of an applique should be considered in the broad sense. The applique can thus perform:
a function of indicating the time or information derived from the time, and/or
a decorative function.

An applique can therefore potentially perform a solely decorative function.

1. A timepiece dial comprising:
a dial plate,
an applique, and
a pressing element, the applique being retained between the dial plate and the pressing element.

2. The timepiece dial as claimed in claim 1, wherein
the dial plate comprises at least one first positioning and/or fastening element, and
the pressing element comprises at least one second positioning and/or fastening element cooperating with the at least one first positioning and/or fastening element.

3. The timepiece dial as claimed in claim 1, wherein the dial comprises interface surfaces between the dial plate and the pressing element, wherein the interface surfaces are arranged
in a thickness of the dial plate, and/or
in a thickness of the applique, and/or
in a thickness of the pressing element.

4. The timepiece dial as claimed in claim 2, wherein a the at least one first positioning and/or fastening element comprises a foot or a hole, and/or a the at least one second positioning and/or fastening element comprises a hole a foot.

5. The timepiece dial as claimed in claim 1, wherein the foot comprises a deformable end.

6. The timepiece dial as claimed in claim 1, wherein the dial plate and/or the pressing element is/are provided with an opening for receiving the applique, the dial plate and/or the pressing element comprising at least one third positioning element, the applique comprising at least one fourth positioning element cooperating with the at least one third element.

7. The timepiece dial as claimed in claim 1, wherein the dial comprises interface surfaces between the dial plate and the applique and/or between the pressing element and the applique, the interface surfaces being arranged
in a thickness of the dial plate, and/or
in a thickness of the applique, and/or
in a thickness of the pressing element.

8. The timepiece dial as claimed in claim 1, wherein the applique comprises at least one first projection outside a first visible zone of the applique.

9. The timepiece dial as claimed in claim 6, wherein
the applique comprises at least one first projection outside a first visible zone of the applique, and
the at least one fourth positioning and/or fastening element is formed by the at least one first projection.

10. The timepiece dial as claimed in claim 9, wherein the at least one third positioning element comprises at least one first recess for receiving the at least one fourth positioning element.

11. The timepiece dial as claimed in claim 2, wherein the at least one first positioning and/or fastening element comprises feet provided on an inner face of the dial plate.

12. The timepiece dial as claimed in claim 2, wherein the at least one second positioning and/or fastening element comprises feet provided on an inner face of the pressing element.

13. The timepiece dial as claimed in claim 1, wherein visible surfaces of at least two of the three members below:
the dial plate,
the applique,
the pressing element,
are flush with one another.

14. The timepiece dial as claimed in claim 1, wherein:
the applique is disk-shaped and the pressing element is annular, or
the applique is annular and the pressing element is disk-shaped.

15. A timepiece comprising the timepiece dial as claimed in claim 1.

16. The timepiece dial as claimed in claim 5, wherein the deformable end of the foot is a rivet end.

17. The timepiece dial as claimed in claim 11, wherein the feet of the at least one first positioning and/or fastening element provided on the inner face of the dial plate are provided on an interface surface between the dial plate and the pressing element.

18. The timepiece dial as claimed in claim 12, wherein the feet of the at least one second positioning and/or fastening element provided on the inner face of the pressing element are provided on an interface surface between the dial plate and the pressing element.

19. The timepiece dial as claimed in claim 2, wherein the dial comprises interface surfaces between the dial plate and the pressing element, wherein the interface surfaces are arranged
in a thickness of the dial plate, and/or
in a thickness of the applique, and/or
in a thickness of the pressing element.

20. The timepiece dial as claimed in claim 19, wherein
the at least one first positioning and/or fastening element comprises a foot or a hole, and/or
the at least one second positioning and/or fastening element comprises a hole or a foot.
